(19) United States
(12) Patent Application Publication
(10) Pub. No.: US 2022/0356755 A1
(43) Pub. Date: Nov. 10, 2022

(54) WINDOW BLIND SLAT ATTACHMENT

(71) Applicant: Lutron Technology Company LLC, Coopersburg, PA (US)

(72) Inventors: David A. Kirby, Zionsville, PA (US); Glenn S. Laverty, IV, Cooperburg, PA (US); Mailing Ren Wu, Lansdale, PA (US)

(73) Assignee: Lutron Technology Company LLC, Coopersburg, PA (US)

(21) Appl. No.: 17/623,384

(22) PCT Filed: Jul. 24, 2020
(86) PCT No.: PCT/US2020/043433

§ 371 Date: Dec. 28, 2021

Related U.S. Application Data
(60) Provisional application No. 62/878,106, filed on Jul. 24, 2019.

(51) Int. Cl. E06B 9/384; E06B 9/303

(52) U.S. Cl. CPC E06B 9/384; E06B 9/303

(57) ABSTRACT

A window treatment may include a headrail, a weighting element, a plurality of slats, one or more first ladder cords, one or more second ladder cords, a plurality of ladder rungs, and one or more couplings. The plurality of slats may be located between the headrail and the weighting element. Each of the plurality of slats may include an upper surface and a lower surface. The plurality of ladder rungs may extend between a first ladder cord and a second ladder cord. The lower surface of each of the plurality of slats may rest on a respective ladder rung of the plurality of ladder rungs. The one or more couplings may be configured to be attached to respective slats of the plurality of slats. The coupling may be configured to be removed such that the slat can be removed from the window treatment.

### CROSS-REFERENCE TO RELATED APPLICATIONS

This application claims the benefit of Provisional U.S. Patent Application No. 62/878,106, filed Jul. 24, 2019, the entire disclosure of which is hereby incorporated by reference herein in its entirety.

### BACKGROUND

Window treatments typically include a flexible fabric, blind slats, or other means for covering a window in order to block or limit the daylight entering a space and to provide privacy. The window treatments may include roller shades, cellular shades, Roman shades, Venetian blinds, and draperies. Venetian or horizontal blinds may have mechanisms to raise/lower and tilt the slats.

### SUMMARY

Mechanisms to tilt the slats may result in openings in the slats that are visible when the blinds are closed, which may reduce privacy and allow unwanted light to penetrate the room. A window treatment may include a headrail, a weighting element, a plurality of slats, one or more first ladder cords, one or more second ladder cords, a plurality of ladder rungs, and one or more couplings. The headrail may be elongate along a first direction. The headrail may be configured to be mounted to a structure. The weighting element may be configured such that the window treatment hangs down in front of a window. The plurality of slats may be located between the headrail and the weighting element. Each of the plurality of slats may include an upper surface and a lower surface. A first ladder cord may extend along a second direction between the headrail and the weighting element on a first side of the plurality of slats. A second ladder cord may extend along the second direction between the headrail and the weighting element on a second side of the plurality of slats. The plurality of ladder rungs may extend between the first ladder cord and the second ladder cord. The lower surface of each of the plurality of slats may rest on a respective ladder rung of the plurality of ladder rungs.

The one or more couplings may be configured to be attached to respective slats of the plurality of slats. For example, a coupling may be configured to removably attach a slat to a corresponding ladder rung on which the slat rests. The coupling may be configured to be removed such that the slat can be removed from the window treatment. The corresponding ladder rung may remain intact and undamaged when the coupling is removed. The removed coupling may be configured to be reattached to a replacement slat that is installed onto the corresponding ladder rung.

Each of the plurality of slats may include one or more holes that extend from the upper surface to the lower surface. The one or more holes may be located proximate to the first ladder cord. Each of the one or more holes may be configured to receive a portion of the coupling. The coupling may be a clip that defines a curved portion and two compliant members. The clip may be a metal wire. The two compliant members may extend from the curved portion. Each of the two compliant members may be curved such that when a portion of the coupling is received within the hole, the compliant members are proximate to each other within the hole and distal portions of the compliant members abut the upper surface of the slat. The curved portion and the two compliant members may be configured to retain the ladder rung within the coupling when the portion of the coupling is received within the hole. The distal portions of the compliant members may be inserted into the hole from the lower surface of the slat. The distal portions of the compliant members may be configured to be pushed together to enable the clip to be removed from a lower surface of the slat. The hole and the coupling may be hidden when the window treatment is in a closed position.

Each of the plurality of slats may include one or more notches proximate to the first ladder cord. A lower surface of each of the plurality of slats may be configured to rest on one or more ladder rungs. The one or more ladder rungs may be attached to the first ladder cord. The notches may be configured to receive a corresponding ladder rung. The coupling may be configured to secure the ladder rung within the notch. The coupling may include an arm that bridges the notch, for example, to secure (e.g., captively retain) the ladder rung within the notch (e.g., between the arm and the slat. The arm may be attached to the slat via one or more mechanisms, such as adhesive. A rear surface of the slat may include holes on either side of the notch. The coupling may include legs that extend from opposed sides of the arm. The legs may extend substantially perpendicular to the arm. The legs may be received within the holes. The coupling may be a bent metal wire. The coupling may be configured to be removed from the slat and reattached to the slat or a replacement slat that is installed onto the ladder rung.

### BRIEF DESCRIPTION OF THE DRAWINGS

FIG. 1 is a perspective view of an example window blind.

FIG. 2A is a partial perspective view of an example window blind system with slat attachment hangers.

FIG. 2B is a partial cross-section view of the example window blind system of FIG. 2A.

FIG. 2C is another partial cross-section view of the example window blind system of FIG. 2A.

FIG. 2D is another partial cross-section view of the example window blind system of FIG. 2A.

FIG. 3A is a partial perspective view of another example window blind system with a removable attachment mechanism.

FIG. 3B is a partial cross-section view of the example window blind system of FIG. 3A.

FIG. 3C is a partial top view of a slat of the example window blind system with a coupling attached of FIG. 3A.

### DETAILED DESCRIPTION

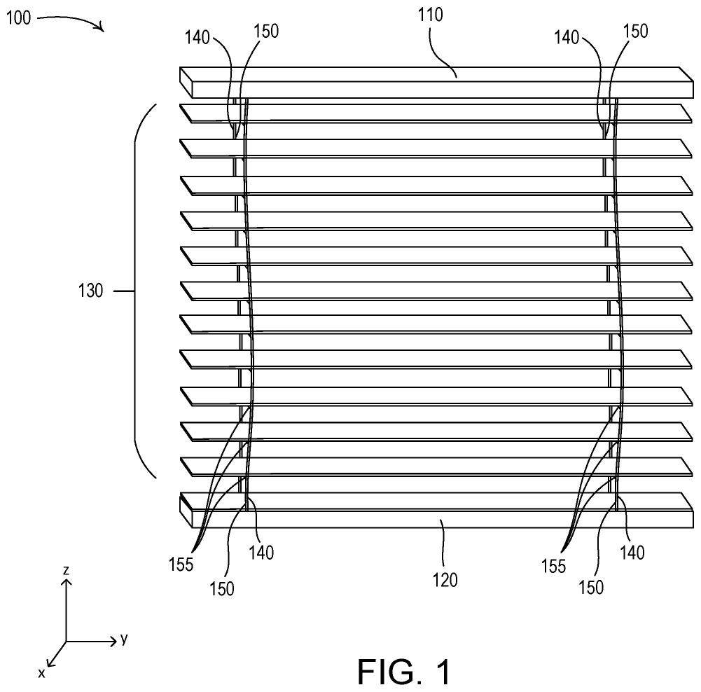

FIG. 1 is a perspective view of an example window treatment 100 that may be mounted, for example, in front of a window (not shown). The window treatment 100 may be manually operated. Alternatively, the window treatment 100 may be motorized. For example, the window treatment 100 may include a drive assembly (not shown). The window treatment 100 may include a plurality of slats 130. The window treatment 100 may be mounted such that the plurality of slats 130 are able to hang in front of the window, and may be adjusted between a fully-open position P_{FULLY-OPEN} and a fully-closed position P_{FULLY-CLOSED} to control the amount of daylight entering a room or space. The plurality of slats 130 may be configured to be raised, lowered, and/or tilted. For example, the plurality of slats 130 may be raised and lowered using one or more lift cords, for example, such as the lift cords 140. The lift cords 140 may be connected to a headrail 110 (e.g., at the top of the window treatment 100) and a weighting element 120 (e.g., at the bottom of the window treatment 100). The lift cords 150 may extend between the headrail 110 and the weighting element 120 on the window side and the non-window side of the window treatment 100. The weighting element 120 may be a bottom bar. The headrail 110 may extend between opposite ends that are connected to mounting brackets. The lift cords 140 may extend between the headrail 110 and the weighting element 120 on the window side and/or the non-window side of the window treatment 100. The lift cords 140 may be configured to raise the weighting element 120 towards the headrail 110 and lower the weighting element 120 away from the headrail 110.

The window treatment 100 may include tilt ladder cords 150 and ladder rungs 155. The tilt ladder cords 150 and ladder rungs 155 may be configured to tilt the plurality of slats 130 between the fully-open position P_{FULLY-OPEN} and the fully-closed position P_{FULLY-CLOSED}, for example, to control the amount of daylight entering a room or space. The tilt ladder cords 150 may extend between the headrail 110 and the weighting element 120 on the window side and/or the non-window side of the window treatment 100. The ladder rungs 155 may be referred to as tilt members. The ladder rungs 155 may be connected to respective tilt ladder cords 150. The ladder rungs 155 may extend between respective tilt ladder cords 150. For example, one or more ladder rungs 155 (e.g., separated in the y-direction) may extend underneath each slat of the plurality of slats 130. The plurality of slats 130 may rest on the ladder rungs 155 (e.g., between the respective tilt ladder cords 150). For example, one or more ladder rungs 155 may support (e.g., vertically support) each slat of the plurality of slats 130.

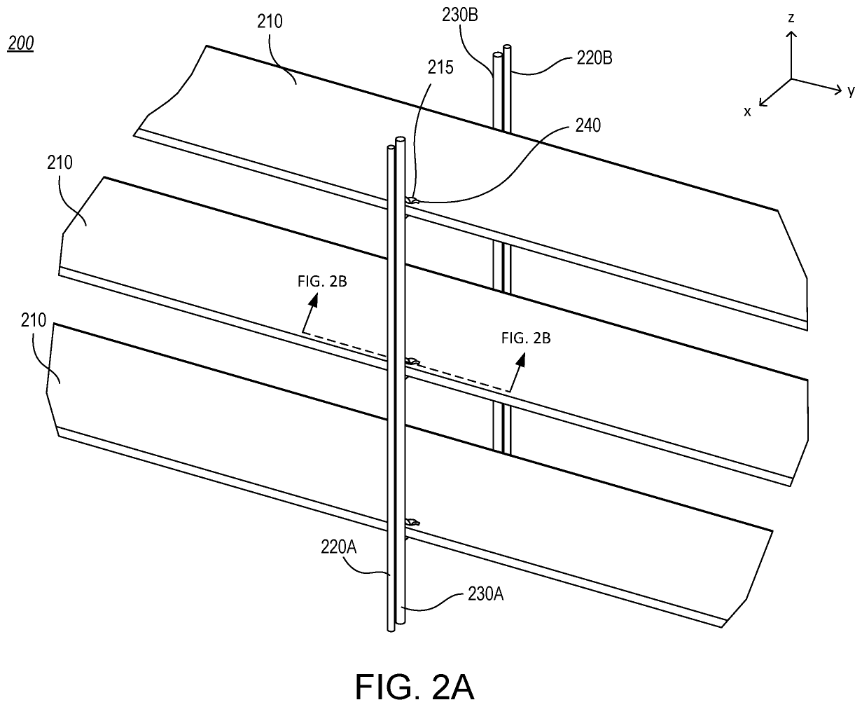

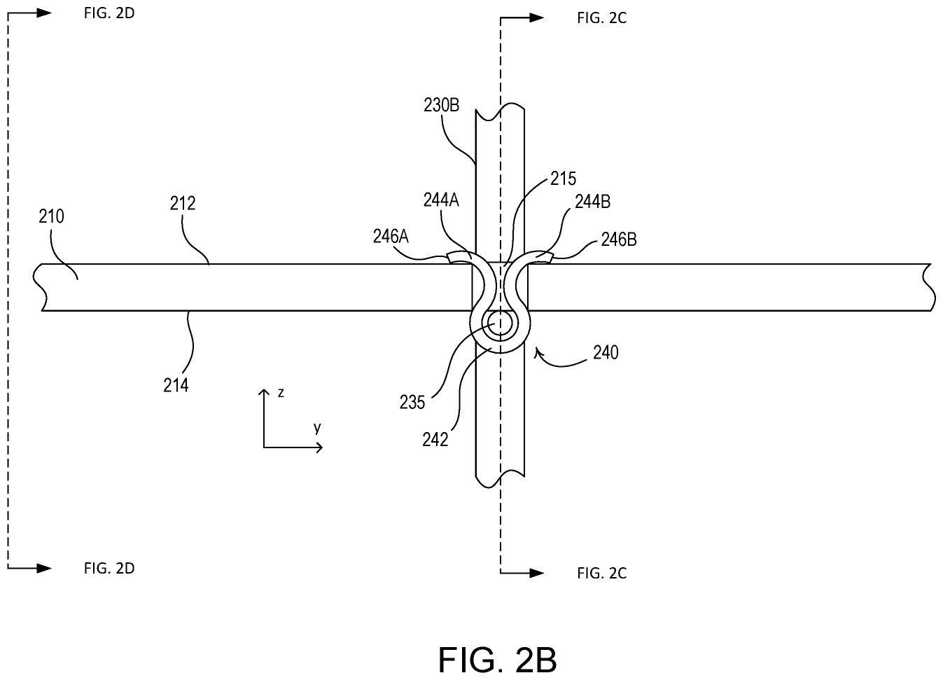

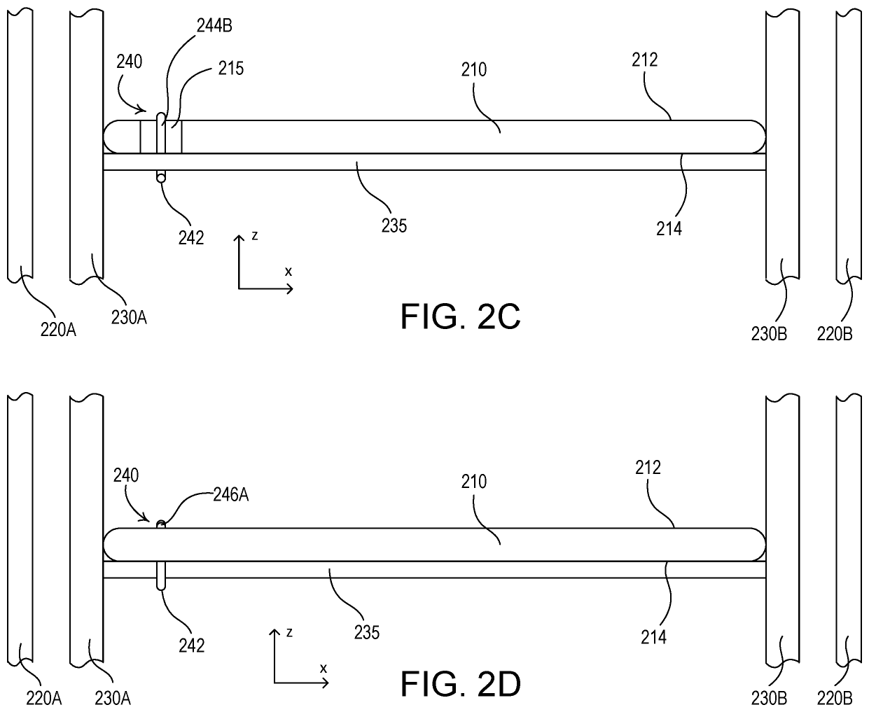

FIGS. 2A-2D depict an example window treatment 200 (e.g., such as the window treatment 100 shown in FIG. 1) that may be mounted, for example, in front of a window (not shown). The window treatment 200 may include a plurality of slats 210, lift cords 220A, 220B (e.g., such as the lift cords 140 shown in FIG. 1), tilt ladder cords 230A, 230B (e.g., such as the tilt ladder cords 150 shown in FIG. 1), and/or ladder rungs 235 (e.g., such as the ladder rungs 155 shown in FIG. 1). One will understand that additional lift cords, tilt ladder cords, and/or ladder rungs may be incorporated along the slat (i.e.,, each slat may have at least two lift cords, tilt ladder cords, and ladder rungs). The lift cords 220A, 220B may extend between a headrail (e.g., such as the headrail 110 shown in FIG. 1) and a weighting element (e.g., the weighting element 120 shown in FIG. 1) on the window side and/or the non-window side of the window treatment 200. For example, lift cords 220A may be located on the window side of the window treatment 200 and lift cords 220B may be located on the non-window side of the window treatment 200. The window treatment 200 may include two or more sets of lift cords 220A, 220B that are spaced apart in the y-direction. The window treatment 200 may include two or more sets of tilt ladder cords 230A, 230B that are spaced apart in the y-direction. The window treatment 200 may include two or more ladder rungs 235 per slat of the plurality of slats 210. Each of the plurality of slats 210 may include an upper surface 212 and a lower surface 214. The upper surface 212 may face the headrail and the lower surface 214 may face the weighting element.

The lift cords 220A, 220B may be configured to adjust the window treatment 200 between a raised position and a lowered position. For example, the lift cords 220A, 220B may be configured to raise the weighting element (e.g., and the plurality of slats 210) towards the headrail and lower the weighting element (e.g., and the plurality of slats 210) away from the headrail to control the amount of daylight entering a room or space. As the lift cords 220A, 220B raise the weighting element, the weighting element may abut a lowermost slat (e.g., the lower surface 214) of the plurality of slats 210 such that the lowermost slat of the plurality of slats 210 is raised as the weighting element continues to be raised. As the lift cords 220A, 220B continue to raise the weighting element, the lowermost slat (e.g., the upper surface 212) may abut the next slat (e.g., the lower surface 214) of the plurality of slats 210 such that the next slat is raised as the weighting element continues to be raised. Successive slats of the plurality of slats 210 may be similarly abutted and raised, until the lift cords 220A, 220B stop raising the weighting element.

The tilt ladder cords 230A, 230B and the ladder rungs 235 may be configured to tilt the plurality of slats 210 between an open position (e.g., fully-open position P_{FULLY-OPEN}) and a closed position (e.g., fully-closed position P_{FULLY-CLOSED}), for example, to control the amount of daylight entering a room or space. The plurality of slats 210 may be horizontal when in the open position. The plurality of slats 210 may be substantially vertical when in the closed position. The tilt ladder cords 230B and/or the tilt ladder cords 230A may be configured to move vertically in the z-direction such that the ladder rungs 235 tilt the plurality of slats 210 between the open position and the closed position. The tilt ladder cords 230A, 230B may extend between the headrail and the weighting element on the window side and/or the non-window side of the window treatment 200. The ladder rungs 235 may extend between respective tilt ladder cords 230A, 230B on the window side and the non-window side of the window treatment 200.

The ladder rungs 235 may be referred to as tilt members. The ladder rungs 235 may be connected to respective tilt ladder cords 230A, 230B. For example, two or more tilt ladder cords 230A may be located on the window side of the window treatment 200 and two or more tilt ladder cords 230B may be located on the non-window side of the window treatment 200. The tilt ladder cords 230A may be referred to as first tilt ladder cords. The tilt ladder cords 230B may be referred to as second tilt ladder cords. The plurality of slats 210 may rest on the ladder rungs 235. For example, two or more ladder rungs 235 (e.g., spaced in the y-direction proximate to a left and right side of the window treatment 200) may support (e.g., vertically support) each slat of the plurality of slats 210.

Each of the plurality of slats 210 may be attached (e.g., removably attached) to a respective one of the ladder rungs 235. The window treatment 200 may include a plurality of couplings 240. The couplings 240 may be configured to attach (e.g., removably attach) or couple the plurality of slats 210 to the ladder rungs 235. For example, each of the plurality of couplings 240 may be configured to engage a respective slat of the plurality of slats 210 and a corresponding one of the ladder rungs 235. Each slat of the plurality of slats 210 may have one or multiple couplings 240, for example, two couplings. Each of the couplings 240 may be configured to be removed from the slats 210 such that the slats 210 may be removed from the window treatment 200 to clean and/or replace the slat(s). When a coupling of the couplings 240 is removed, a corresponding ladder rung of the ladder rungs 235 may remain intact and may be undamaged. The removed coupling of the couplings 240 may be reattached to a removed and/or replacement slat that is installed onto the corresponding ladder rung of the ladder rungs 235 without damaging the slat, for example.

Each of the plurality of slats 210 may include one or more holes 215. The number of holes 215 in each of the plurality of slats 210 may be equal to the number of ladder rungs 235 supporting each of the plurality of slats 210. The holes 215 may extend from the upper surface 212 to the lower surface 214. The holes 215 may be located proximate to the tilt ladder cords 230A (e.g., on the window side of the window treatment 200). When the holes 215 are located proximate to a window side of window treatment 200, the holes 215 may be hidden from view when the plurality of slats 210 are tilted/partially tilted towards the fully-closed position P_{FULLY-CLOSED}. The holes 215 may be located on the plurality of slats 210 such that they are aligned (e.g., horizontally in the y-direction) with the ladder rungs 235 such that the ladder rungs 235 pass across respective holes 215. Each of the holes 215 may be configured to receive a portion of a respective coupling 240. For example, a coupling 240 may be inserted into a hole 215 to removably attach the slat 210 to the ladder rung 235. A portion of the coupling 240 may be inserted into the hole 215 from the lower surface 214 of the slat 210.

The coupling 240 may be a clip (e.g., a window treatment slat clip) that defines a base portion 242 and compliant members 244A, 244B. The compliant members 244A, 244B may extend from the base portion 242. The base portion 242 may be curved, for example, as shown in FIG. 2B. It should be appreciated that the base portion 242 may be alternately shaped (e.g., straight, diamond-shaped, triangular, etc.). The compliant members 244A, 244B may be the portion of the coupling 240 that is inserted into the hole 215. The compliant members 244A, 244B may define respective distal portions 246A, 246B. The distal portions 246A, 246B may be pushed through the hole 215 and may abut the upper surface 212 of the slat 210. The compliant members 244A, 244B may be curved such that the compliant members 244A, 244B are proximate to each other within the hole 215 and the distal portions 246A, 246B abut the upper surface 212 of the slat 210. The coupling 240 (e.g., the base portion 242 and the compliant members 244A, 244B) may be configured to retain the corresponding ladder rung of the ladder rungs 235 within the coupling 240 when the portion of the coupling is received within the hole 215. The corresponding ladder rung of the ladder rungs 235 may remain between the base portion 242 and the compliant members 244A, 244B below the lower surface 214 of the slat 210. For example, the corresponding ladder rung of the ladder rungs 235 may be proximate to the base portion 242 when the coupling 240 is received within the hole 215. The compliant members 244A, 244B may prevent the corresponding ladder rung from extending into the hole 215. The coupling 240 may be configured to couple the slat 210 to the corresponding ladder rung of the ladder rungs 235.

Although the figures show the coupling 240 coupling the slats 210 to the ladder rungs 235, it should be appreciated that the coupling 240 may additionally or alternatively couple the slats 210 to the tilt ladder cords 230A. For example, the coupling 240 may be configured to secure a respective tilt ladder cord 230A and/or a corresponding ladder rung 235 within a respective hole 215.

The window treatment 200 may be operated between the open position and the closed position. The open position may be defined as the plurality of slats 210 being substantially parallel to one another in a horizontal position with respect to the window such that a user can see the window through the slats. The closed position may be defined as each of the plurality of slats 210 overlapping and/or abutting one another such that the slats 210 are in a substantially vertical position, thereby obstructing a user's view of the window through the slats. The tilt ladder cord 230B (e.g., distal to the hole 215) may be translated up and down to operate the plurality of slats 210 between the open position and the closed position. As the tilt ladder cord 230B is translated, a side of each of the plurality of slats 210 distal from the hole 215 is raised or lowered (e.g., based on the direction the tilt ladder cord 230B is translated). As the plurality of slats 210 are raised or lowered, adjacent slats of the plurality of slats 210 may begin to overlap one another. For example, a non-window side of a first slat may overlap (e.g., in the z-direction) a window side of a second slat, a non-window side of the second slat may overlap a window side of a third slat, and so on. As the non-window side of a slat overlaps a window side of an adjacent slat, the hole 215 and coupling 240 may be hidden from view on a non-window side of the window treatment 200. Additionally or alternatively, the tilt ladder cord 230A (e.g., proximate to the hole 215) may be translated up and down to operate the plurality of slats 210 between the open position and the closed position. For example, a lower surface 214 of one slat may overlap an upper surface 212 of another slat when the window treatment 200 is in the closed position. The plurality of slats 210 may be configured to prevent light from penetrating a room when in the closed position. The coupling 240 and the hole 215 may be hidden from view (e.g., on the non-window side of the window treatment 200) when the window treatment 200 is in the closed position. For example, the coupling 240 and the hole 215 for a first slat may be hidden by a second slat that overlaps the first slat.

The coupling 240 may be configured to be removed (e.g., from the hole 215) such that the slat 210 can be removed from the window treatment 200. The distal portions 246A, 246B of the compliant members 244A, 244B may be configured to be pushed together, for example, to enable the coupling 240 to be removed from the lower surface 214 of the slat 210.

According to one example, the coupling 240 as shown in FIGS. 2A-2D may be a metal wire. For example, the coupling 240 may be deformed (e.g., bent) from a straight metal wire into the shape shown in FIG. 2B as it is inserted into the hole 215. Alternatively, the coupling 240 may be in the shape shown in FIG. 2B before being installed into the hole 215. The distal portions 246A, 246B of the compliant members 244A, 244B may be compressed or squeezed together to fit through the hole 215. It should be appreciated that the coupling 240 is not limited to a metal wire, but may be made of any material that allows it to be compressed to squeeze or insert into the hole 215, and provides tension to retain its position in the slat once inserted. Alternatively, the coupling 240 may be a thin and/or flat piece of metal, plastic, etc. The coupling 240 may be a single piece (e.g., molded, formed, cast, etc.). Alternatively, the coupling 240 may include multiple pieces that are attached together.

Although the figures show an example geometry of the coupling 240, it should be appreciated that the coupling 240 is not limited to this example geometry. Stated differently, the coupling 240 may have alternative geometry to that shown in the figures and still attach (e.g., removably attach) a slat of the plurality of slats 210 to a corresponding ladder rung of the plurality of ladder rungs 235 on which the slat rests. As another example, the coupling 240 may comprise a snap (e.g., an annular snap, a cantilever snap, or a torsional snap). The coupling 240 may be snap-fit to the slat 210 (e.g., within the hole 215). A distal portion of the snap may be received (e.g., captively received) within the hole 215 such that the slat 210 is coupled to the corresponding ladder rung of the plurality of ladder rungs 235.

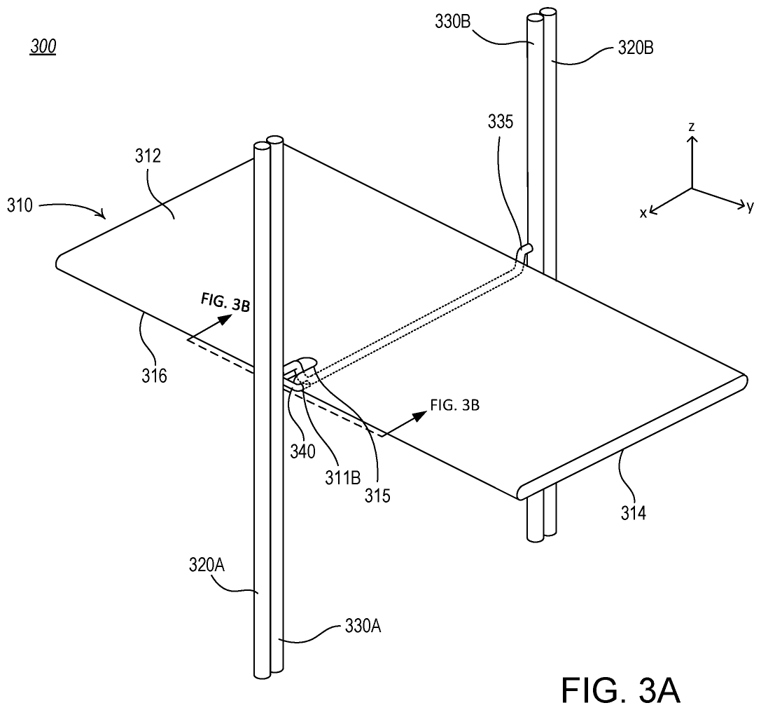

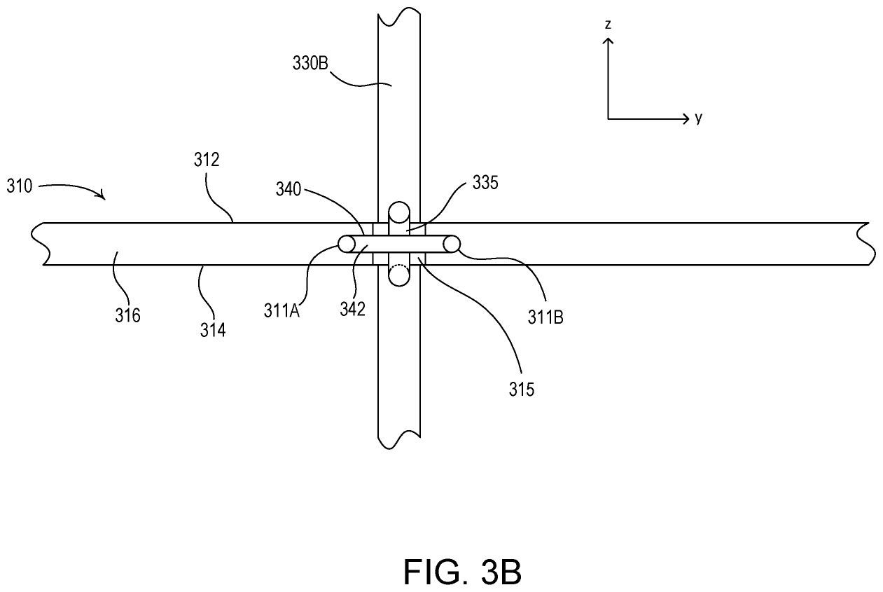

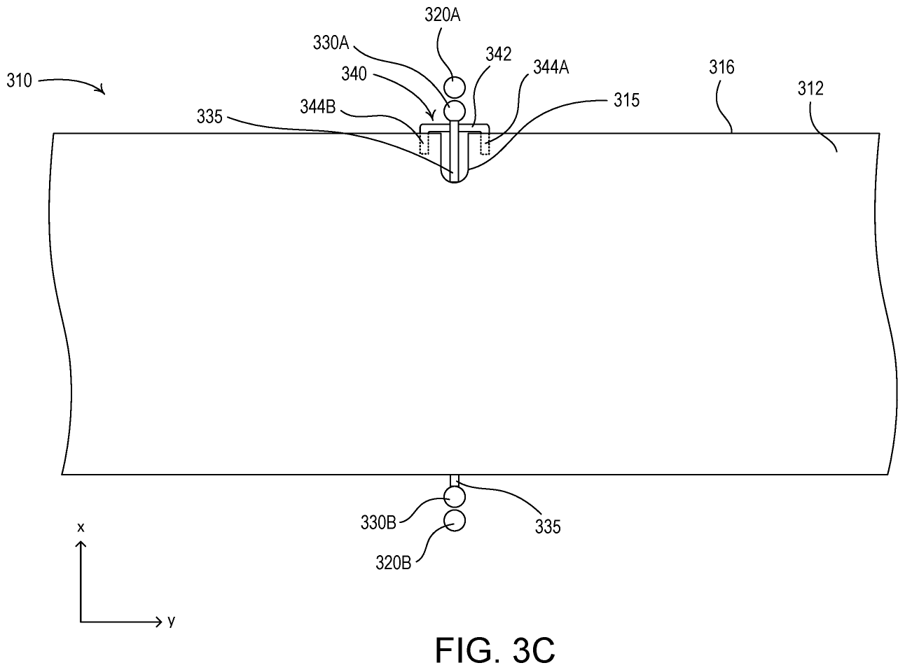

FIGS. 3A-3C depict a portion of another example window treatment 300 (e.g., such as the window treatment 100 shown in FIG. 1) that may be mounted, for example, in front of a window (not shown). The window treatment 300 may include a plurality of slats 310 (only one is shown), lift cords 320A, 320B (e.g., such as the lift cords 140 shown in FIG. 1 and/or the lift cords 220A, 220B shown in FIGS. 2A-2D), tilt ladder cords 330A, 330B (e.g., such as the tilt ladder cords 150 shown in FIG. 1 and/or the tilt ladder cords 230A, 230B shown in FIGS. 2A-2D), and/or ladder rungs 335 (e.g., such as the ladder rungs 155 shown in FIG. 1 and/or the ladder rungs 235 shown in FIGS. 2A-2D). One will understand that additional lift cords, tilt ladder cords, and/or ladder rungs may be incorporated along the slat (e.g., each slat may have at least two lift cords, tilt ladder cords, and ladder rungs). The lift cords 320A, 320B may extend between a headrail (e.g., such as the headrail 110 shown in FIG. 1) and a weighting element (e.g., the weighting element 120 shown in FIG. 1) on the window side and/or the non-window side of the window treatment 300. For example, lift cords 320A may be located on the window side of the window treatment 300 and lift cords 320B may be located on the non-window side of the window treatment 300. Each of the plurality of slats 310 may include an upper surface 312 and a lower surface 314. The upper surface 312 may face the headrail and the lower surface 314 may face the weighting element. For example, the lower surface 314 may be configured to rest on the ladder rungs 335.

The lift cords 320A, 320B may be configured to adjust the window treatment 300 between a raised position and a lowered position. For example, the lift cords 320A, 320B may be configured to raise the weighting element (e.g., and the plurality of slats 310) towards the headrail and lower the weighting element (e.g., and the plurality of slats 310) away from the headrail to control the amount of daylight entering a room or space. As the lift cords 320A, 320B raise the weighting element, the weighting element may abut a lowermost slat (e.g., the lower surface 314) of the plurality of slats 310 such that the lowermost slat of the plurality of slats 310 is raised as the weighting element continues to be raised. As the lift cords 320A, 320B continue to raise the weighting element, the lowermost slat (e.g., the upper surface 312) may abut the next slat (e.g., the lower surface 314) of the plurality of slats 310 such that the next slat is raised as the weighting element continues to be raised. Successive slats of the plurality of slats 310 may be similarly abutted and raised, until the lift cords 320A, 320B stop raising the weighting element.

The tilt ladder cords 330A, 330B and the ladder rungs 335 may be configured to tilt the plurality of slats 310 between an open position (e.g., fully-open position P_{FULLY-OPEN}) and a closed position (e.g., fully-closed position P_{FULLY-CLOSED}), for example, to control the amount of daylight entering a room or space. The plurality of slats 310 may be horizontal when in the open position. The plurality of slats 310 may be substantially vertical when in the closed position. The tilt ladder cords 330B and/or the tilt ladder cords 330A may be configured to move vertically in the z-direction such that the ladder rungs 335 tilt the plurality of slats 310 between the open position and the closed position. The tilt ladder cords 330A, 330B may extend between the headrail and the weighting element on the window side and/or the non-window side of the window treatment 300.

The ladder rungs 335 may be referred to as tilt members. The ladder rungs 335 may be connected to respective tilt ladder cords 330A, 330B. The ladder rungs 335 may extend between the respective tilt ladder cords 330A, 330B on the window side and the non-window side of the window treatment 300. For example, tilt ladder cords 330A may be located on the window side of the window treatment 300 and tilt ladder cords 330B may be located on the non-window side of the window treatment 300. The tilt ladder cords 330A may be referred to as first tilt ladder cords. The tilt ladder cords 330B may be referred to as second tilt ladder cords. The plurality of slats 310 may rest on the ladder rungs 335. For example, at least two ladder rungs 335 (e.g., spaced in the y-direction proximate to a left and right side of the window treatment 300) may support (e.g., vertically support) each slat of the plurality of slats 310.

Each of the plurality of slats 310 may be removably attached to a respective one of the ladder rungs 335. The window treatment 300 may include a plurality of couplings 340. The couplings 340 may be configured to attach (e.g., removably attach) or couple the plurality of slats 310 to the ladder rungs 335. For example, each of the plurality of couplings 340 may be configured to engage a respective slat of the plurality of slats 310 and a corresponding one of the ladder rungs 335. Each slat of the plurality of slats 310 may have one or multiple couplings 340, for example, two couplings. Each of the plurality of couplings 340 may be configured to secure the corresponding one of the ladder rungs 335 to the respective slat of the plurality of slats 310. For example, the couplings 340 may insert into a size of the slat. Each of the couplings 340 may be configured to be removed from the slats 310 such that the slats 310 may be removed from the window treatment 300 to clean and/or replace the slat(s). When one or more couplings of the couplings 340 are removed, corresponding ladder rung(s) of the ladder rungs 335 may remain intact and undamaged and a corresponding slat of the slats 310 may be removed from the window treatment 300 for cleaning or replacing the slat. The removed coupling(s) of the couplings 340 may be reattached to a removed and/or replacement slat that is installed onto the corresponding ladder rung of the ladder rungs 335 without damaging the slat, for example, thereby allowing for easy replacement of one or more slats while ensuring the slats remain secured in place with respect to the ladder rungs 335.

Each of the plurality of slats 310 may include one or more notches 315 cut into a lateral side of the slat. The notches 315 may be open at the rear surface 316 of the slat. For example, the notches 315 may be cut into the rear surface 316 of the slat and extend (e.g., in the x-direction) partially into the slat. The notches 315 may be located proximate to the tilt ladder cord 330A (e.g., on the window side of the window treatment 300). There may be a notch 315 per each tilt ladder cord 330A on the respective slat, or one notch per slat (proximate any of the tilt ladder cords for the slat). When the notches 315 are located proximate to a window side of window treatment 300, the notches 315 may be hidden from view when the plurality of slats 310 are tilted. The notches 315 may be located on the plurality of slats 310 such that they are aligned (e.g., in the y-direction) with the ladder rungs 335. Each of the notches 315 may be configured to receive a portion of the ladder rung 335. The coupling 340 may bridge the notch 315 to removably attach the slat 310 to the ladder rung 335. For example, the coupling 340 may be configured to secure the ladder rung 335 within the notch 315.

Although the figures show the coupling 340 coupling the slats 310 to the ladder rungs 335, it should be appreciated that the coupling 340 may additionally or alternatively be configured to couple the slats 310 to the tilt ladder cords 330A. For example, the coupling 340 may be configured to secure a respective tilt ladder cord 330A and/or a corresponding ladder rung 335 within a notch 315.

The window treatment 300 may be operated between the open position and the closed position. The open position may be defined as the plurality of slats 310 being substantially parallel to one another in a horizontal position with respect to the window. The closed position may be defined as each of the plurality of slats 310 overlapping and/or abutting one another such that the slats 310 are in a substantially vertical position. The tilt ladder cord 330B (e.g., distal to the notch 315) may be translated up and down to operate the plurality of slats 310 between the open position and the closed position. As the tilt ladder cord 330B is translated, a side of each of the plurality of slats 310 distal from the notch 315 is raised or lowered (e.g., based on the direction the tilt ladder cord 330B is translated). As the plurality of slats 310 are raised or lowered, adjacent slats of the plurality of slats 310 may begin to overlap one another. For example, a non-window side of a first slat may overlap (e.g., in the z-direction) a window side of a second slat, a non-window side of the second slat may overlap a window side of a third slat, and so on. As the non-window side of a slat overlaps a window side of an adjacent slat, the notch 315 and coupling 340 may be hidden from view on a non-window side of the window treatment 300. Additionally or alternatively, the tilt ladder cord 330A (e.g., proximate to the notch 315) may be translated up and down to operate the plurality of slats 310 between the open position and the closed position. For example, a lower surface of one slat may overlap an upper surface of another slat when the window treatment 200 is in the closed position. The plurality of slats 310 may be configured to prevent light from penetrating a room when in the closed position. The coupling 340 and the notch 315 may be hidden from view when the window treatment 300 is in the closed position. For example, the coupling 340 and the notch 315 for a first slat may be hidden by a second slat that overlaps the first slat.

The coupling 340 may be referred to as a slat fastener. The coupling 340 may include an arm 342 that bridges the notch 315, for example, to secure the ladder rung 335 within the notch 315. The arm 342 may be attached to the slat 310. For example, the arm 342 may be attached to the slat 310. The arm 342 may be attached to the slat using adhesive. The arm 342 may bridge the notch 315 defined by the slat 310. The arm 342 may be configured to captively retain the ladder rung 335 on which the slat 310 rests within the notch 315.

The coupling 340 may include legs 344 that extend from opposed ends of the arm 342, for example, in the shape of a staple. The legs 344 may be perpendicular to the arm 342. The legs 344 may be configured to attach (e.g., removably) the coupling 340 to the slat 310. For example, the legs 344 may be configured to be attached to the rear surface 316 of the slat 310, for example, on either side of the notch 315. The legs 344 may be inserted into a rear surface 316 of the slat 310, for example, on either side of the notch 315. The slat 310 (e.g., the rear surface 316 of the slat 310) may define holes 311 that are configured to receive the legs 344. It should be appreciated that the coupling 340 may be attached to the slat 310 in alternate ways. For example, although the coupling 340 (e.g., the arm 342) has been described as attached to the slat 310 with adhesive, other alternative attachment mechanisms are contemplated. For example, the legs 344 of the coupling 340 may be friction fit into the holes 311. In another example, the legs 344 of the coupling 340 may be secured into the holes 311 with fasteners. Although the figures show the coupling 340 attached to the rear surface 316 of the slat 310, it should be appreciated that the coupling 340 may be attached, proximate to the rear surface 316, to the upper surface 312 and/or the lower surface 314 of the slat 310.

Although figures show an example geometry of the slat 310 that includes the notch 315, it should be appreciated that the slat 310 is not limited to this example geometry. Stated differently, the slat 310 may be solid (e.g., along the rear surface 316 and not include notch(es) 315) and the coupling 340 may secure the ladder rung 355 to the rear surface 316 of the slat 310. For example, the coupling 340 may pinch the ladder rung 355 at the rear surface 316 of the slat 310.

As another example, the coupling 340 may comprise a snap (e.g., an annular snap, a cantilever snap, or a torsional snap). The coupling 340 may be snap-fit to the slat 310 (e.g., across the notch 315). A distal portion of the snap may be received (e.g., captively received) within the notch 315 such that the slat 310 is coupled to the corresponding ladder rung of the plurality of ladder rungs 335.

Additionally, although the example couplings are described herein as removably attaching to the slats, one will understand that various other options are possible. For example, the couplings may be a one-way (i.e., permanent) attachment method. In another example, the couplings may not attach directly to the slats, but may attach to the lift cords, tilt cords, a vertical ladder support, etc.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A window treatment comprising:
a headrail that is elongate along a first direction and is configured to be mounted to a structure;
a weighting element configured such that the window treatment hangs down in front of a window;
a plurality of slats between the headrail and the weighting element, each of the plurality of slats comprising an upper surface and a lower surface;
a first ladder cord that extends along a second direction between the headrail and the weighting element on a first side of the plurality of slats;
a second ladder cord that extends along the second direction between the headrail and the weighting element on a second side of the plurality of slats;
a plurality of ladder rungs that extend between the first ladder cord and the second ladder cord such that the lower surface of each of the plurality of slats rests on a respective ladder rung of the plurality of ladder rungs; and
a coupling that is configured to attach a slat of the plurality of slats to a corresponding ladder rung of the plurality of ladder rungs on which the slat rests.

2. The window treatment of claim 1, wherein the coupling is configured to removably attach the slat to the corresponding ladder rung such that the slat can be removed from the window treatment.

3. The window treatment of claim 2, wherein the corresponding ladder rung remains intact and undamaged when the coupling is removed.

4. The window treatment of claim 2, wherein a removed coupling is configured to be reattached to the slat or a replacement slat that is installed onto the corresponding ladder rung.

5. The window treatment of claim 1, wherein the slat comprises a hole from the upper surface to the lower surface proximate to the first ladder cord.

6. The window treatment of claim 5, wherein the hole is configured to receive a portion of the coupling.

7. The window treatment of claim 6, wherein the coupling comprises a clip that defines a curved portion and two compliant members extending from the curved portion.

8. The window treatment of claim 7, wherein each of the two compliant members are curved such that the compliant members are proximate to each other within the hole and distal portions of the compliant members abut the upper surface of the slat.

9. The window treatment of claim 8, wherein the curved portion and the compliant members are configured to retain the corresponding ladder rung within the coupling when the compliant members of the coupling are received within the hole.

10. The window treatment of claim 8, wherein the distal portions of the compliant members are configured to be pushed together to enable the clip to be removed from the lower surface of the slat.

11. The window treatment of claim 10, wherein the distal portions of the compliant members are configured to be inserted into the hole of the slat from the lower surface of the slat.

12. The window treatment of claim 8, wherein the hole and the coupling are hidden on the non-window side of the window treatment when the window treatment is in a closed position.

13. The window treatment of claim 7, wherein the clip comprises a metal wire.

14. The window treatment of claim 1, wherein the slat comprises a notch in a rear surface of the slat and proximate to the first ladder cord.

15. The window treatment of claim 14, wherein the notch is configured to receive the corresponding ladder rung and the coupling is configured to secure the ladder rung within the notch.

16. The window treatment of claim 15, wherein the coupling comprises an arm that bridges the notch to secure the corresponding ladder rung within the notch.

17. The window treatment of claim 16, wherein the rear surface of the slat comprises holes on respective sides of the notch, and wherein the coupling comprises legs that extend from opposed sides of the arm and are received within the holes.

18. The window treatment of claim 17, wherein the coupling comprises a bent metal wire.

19. The window treatment of claim 16, wherein the arm is attached to the slat with adhesive.

20. The window treatment of claim 14, wherein the notch and the coupling are hidden on the non-window side of the window treatment when the window treatment is in a closed position.

21-34. (canceled)
